(19) United States
(12) Patent Application Publication
(10) Pub. No.: US 2003/0041189 A1
(43) Pub. Date: Feb. 27, 2003

(54) Computer system and method of indicating operating states of peripheral devices thereof

(75) Inventors: Seung-Beom Choi, Suwon-city (KR); Sang-Shin Park, Seoul (KR); Eun-Sook Kwon, Seoul (KR)

Correspondence Address: STAAS & HALSEY LLP, 700 11TH STREET, NW, SUITE 500, WASHINGTON, DC, 20001, US

(73) Assignee: Samsung Electronics Co., Ltd., Suwon-city (KR)

(21) Appl. No.: 10/158,920

(22) Filed: Jun. 3, 2002

(30) Foreign Application Priority Data
Aug. 22, 2001 (KR) 2001-50729

(51) Int. Cl. G06F 3/00

(52) U.S. Cl. 710/15

(57) ABSTRACT

A computer system having a main body and fitted with a port to which an peripheral device such as a printer, a camcorder, an MP3 player, a digital camera, a digital TV, etc., is connectable. A monitor outputs a video signal received from the main body to display an operating state of the peripheral device in a window of the monitor. A peripheral device controller provided in the main body detects whether the peripheral device is connected to the port, checks the operating state of the peripheral device if the peripheral device is connected to the port, and outputs information about the state of the peripheral device. The information about the state of the peripheral device is included in the video signal to indicate useful information about the peripheral device to a user of the computer system.

### CROSS REFERENCE TO RELATED APPLICATIONS

This application claims the benefit of Korean Application No. 2001-50729 filed Aug. 22, 2001, in the Korean Patent Office, the disclosure of which is incorporated herein by reference.

### BACKGROUND OF THE INVENTION

1. Field of the Invention

The present invention relates to a computer system and a method of indicating an operating state of peripheral devices of the computer system.

2. Description of the Related Art

Generally, in a conventional computer system, a peripheral device such as a printer, a camcorder, an MP3 (MPEG-1 audio layer 3) player, a digital camera, etc., are operated by being connected to the computer system through a port such as, for example, a serial port, a parallel port, a USB (universal serial bus) port, an IEEE1394 (Institute of Electrical and Electronics Engineers 1394) port, etc.

In the conventional computer system, in a case of a Windows operating system, to know about operating states of the peripheral devices mounted on the computer system through the ports, the operating state can be, as illustrated in FIG. 1, indicated by a device manager 160 of a system register in a control panel.

As shown in FIG. 1, the device manager 160 indicates a model name and a mounting state of hardware components such as the printer, etc., mounted on the computer system. To get detail information such as an IRQ (interrupt request) of the peripheral devices, system resource, device driver, etc., through the device manager 160, the detail information on the peripheral device is acquired by pointing a cursor of a mouse at a chosen peripheral device on a screen and clicking the register information thereof.

However, it is difficult to get more detail information on which port of the computer system each peripheral device is connected. Further, the information indicated on the device manager is not enough to be applied in practical use. For example, in a case of a digital camcorder, there is no information such as, for example, a remaining capacity of a battery or a remaining amount of a recording tape.

### SUMMARY OF THE INVENTION

Accordingly, the present invention has been made, keeping in mind the above-described shortcomings and a user's need for information about the operating state of peripheral devices. An object of the present invention is to provide a computer system and a method of indicating an operating state of peripheral devices thereof, which indicates useful information on the peripheral devices.

Additional objects and advantages of the invention will be set forth in part in the description which follows, and, in part, will be obvious from the description, or may be learned by practice of the invention.

The above and other objects of the present invention are accomplished by providing a computer system comprising a main body fitted with a port to which an peripheral device such as, for example, a printer, is connected, and a monitor which outputs an image corresponding to a video signal received from the main body. A peripheral device controller provided in the main body detects whether the peripheral device is connected to the port, and displays an operating state of the peripheral device by checking the operating state of the peripheral device if the peripheral devices is connected to the port.

The peripheral device controller comprises: a peripheral device detector which detects whether the peripheral device is connected to the port; a peripheral device checker which checks the operating state of the peripheral device if the peripheral device is connected to the port; and an operating state display output which outputs the operating state of the peripheral device checked by the peripheral device checker.

Preferably, the peripheral device controller further comprises a peripheral device installer which registers a peripheral device at the main body where a new peripheral device is mounted on the main body, and the peripheral device controller further comprises an application program runner which runs the application programs while the monitor displays the operating state of the peripheral device.

The peripheral device controller further comprises an application program installer which installs an application program linked with the peripheral device in the main body where the application program linked with the peripheral device is not installed in the main body.

The main body comprises at least one of a serial port, a parallel port, a USB port and an IEEE1394 port, and each port is adapted to receive at least one peripheral device, such as for example, a printer, a digital camcorder, a digital camera or an MP3 player, etc.

The main body further comprises a registry which registers information on the peripheral device, and the information displayed on the monitor comprises the registered information on the peripheral device and the operating state of the peripheral device.

According to another aspect of the present invention, the above and other objects are also achieved by providing a method of indicating an operating state of a peripheral device such as a printer, a digital camcorder, a digital camera or an MP3 player, etc., in a computer system having a main body mounted with a port to which the peripheral device is connected, and a monitor which outputs a video signal received from the main body. The method comprises: detecting whether the peripheral device is connected to the port; checking the operating state of the peripheral device if the peripheral device is connected to the port; and displaying the operating state of the peripheral device on the monitor.

The checking of the operating state of the peripheral device comprises: requesting information on the operating state of the peripheral device from the peripheral device; and transmitting the operating state of the peripheral device through the port, and the detecting of whether the peripheral device is connected to the port comprises registering a peripheral device at the main body where a new peripheral device is connected to the port.

The displaying of the operating state of the peripheral device further comprises: running an application program linked with the peripheral device while visually displaying the operating state of the peripheral device, and the running of the application program further comprises installing the application program linked with the peripheral device in the main body where the application program linked with the peripheral device is not installed in the main body.

The method further comprises registering information on the peripheral device and visually displaying the registered information along with the operating state of the peripheral device.

### BRIEF DESCRIPTION OF THE DRAWINGS

The present invention will be better understood and its various objects and advantages will be more fully appreciated from the following description taken in conjunction with the accompanying drawings, in which:

FIG. 1 shows the conventional device manager indicating information on peripheral devices;

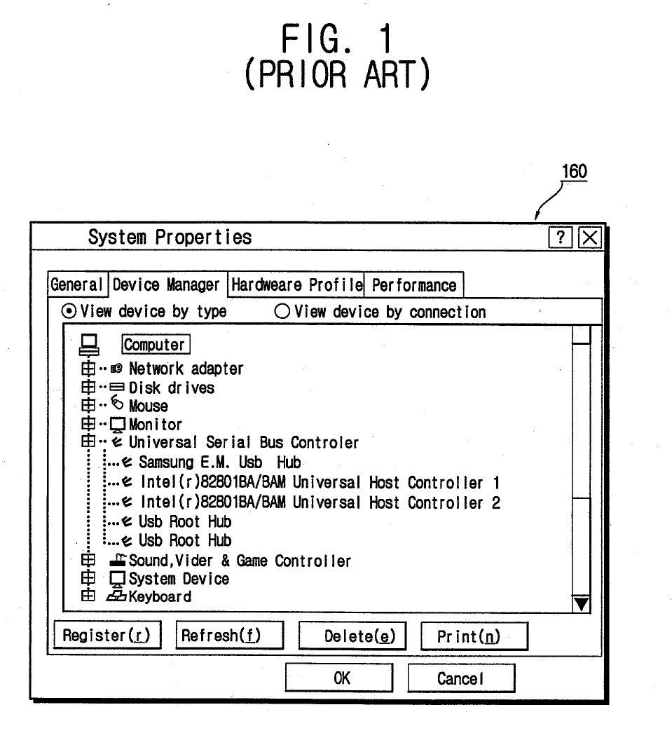

FIG. 2 is a perspective view of a computer system according to the present invention and exemplary peripheral devices;

FIG. 3 is a block diagram of the computer system according to the present invention;

FIG. 4 shows a display window for indicating an operating state of the peripheral devices, according to the present invention;

FIG. 5 shows a display window for operating an application program linked with the peripheral device, according to the present invention; and

FIG. 6 is a flowchart showing a process of displaying the operating state of the peripheral device on a monitor in the computer system according to the present invention.

### DESCRIPTION OF THE PREFERRED EMBODIMENTS

Reference will now be made in detail to the present embodiments of the present invention, examples of which are illustrated in the accompanying drawings, wherein like reference numerals refer to like elements throughout.

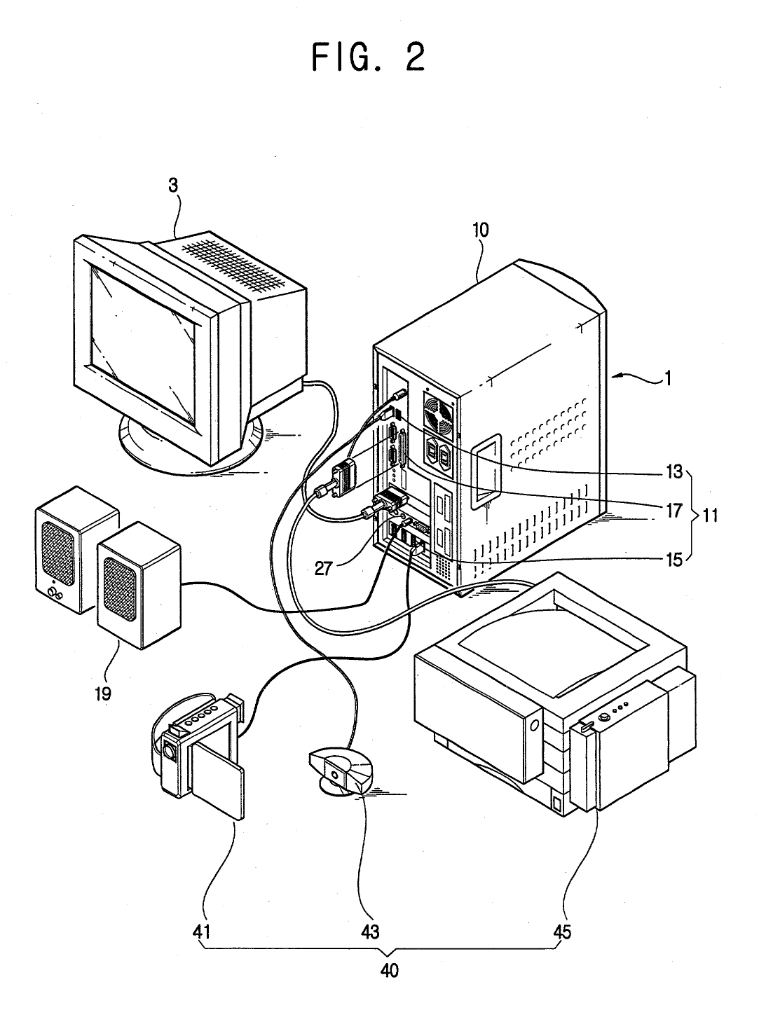

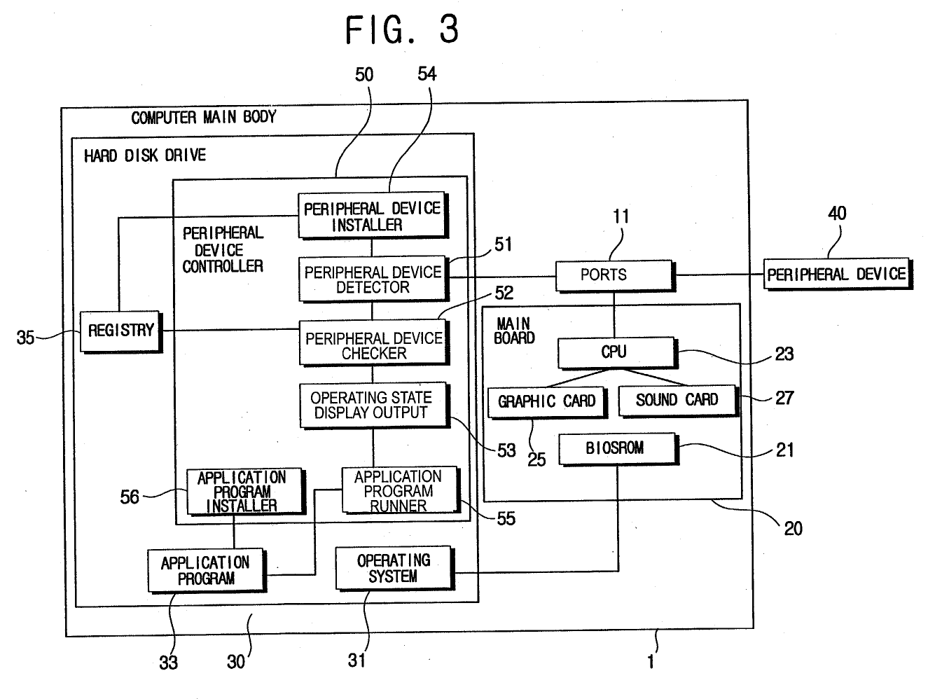

Referring now to FIGS. 2 and 3, a computer system according to the present invention comprises a main body 1 which comprises a plurality of hardware components such as a CPU (central processing unit) 23 (FIG. 3), and a monitor 3 which outputs a video signal received from the main body 1.

The main body 1 further comprises a casing 10 which is fitted with ports 11 to which peripheral devices such as a digital camcorder 41, a digital camera 43, a printer 45, etc. are connectable, and a plurality of hardware components such as a main board 20 (FIG. 3) mounted with the CPU 23, a RAM, etc., which are accommodated in the casing 10.

As shown in FIG. 2, the ports 11 comprise a parallel port 17 to which the printer 45 is connectable, a USB port 13 to which a digital camera 43 is connectable, and an IEEE1394 port 15 to which a digital camcorder 41, a digital TV (not shown), etc., are connectable.

The ports 11 are connected to the main board 20 (FIG. 3) and exposed to the rear of the casing 10, so that the peripheral devices 40 are connectable to the main board 20 through the ports 11.

The IEEE1394 port 15 is for an interface developed by Apple Computer, Inc., which transmits multimedia data between a computer system and appliances connected through a network, with a transmission speed of 100 Mbps ˜1 Gbps. Particularly, in a case of AV (audio and video) appliances such as the digital camcorder 41, the digital camera 43, the digital TV (not shown), etc., data is transmitted through the IEEE1394 port 15 employed as a serial bus with a transmission speed of 400 Mbps.

As shown in FIG. 3, the main board 20 comprises a BIOS-ROM (basic input/output read only memory) 21 for booting the computer system by an operating system 31 stored in a hard disk drive 30, the CPU 23 operates application programs 33, a graphic chip or card 25 generates a video signal as directed by the CPU 23, and a sound card 27 generates an audio signal as directed by the CPU 23.

The main board 20 receives data from the peripheral devices 40 through the ports 11. As the data is received from the peripheral devices 40, video data is outputted to the monitor 3 after being converted into a video signal by the CPU 23 and the graphic chip or card 25, and audio data is outputted to a speaker 19 after being converted into an audio signal by the CPU23 and the sound card 27.

The hard disk drive 30 is provided in the main body 1, and stores the operating system 31 (Windows XP/ME/98/ etc.) which operates the computer system. The application programs 33 are linked with the peripheral devices 40 (e.g., an edit program for editing the video data of the digital camcorder 41, etc.). A registry 35 registers information of the peripheral devices 40, and a peripheral device controller 50 outputs information about operating states of the peripheral devices 40 for presentation on the monitor 3.

The peripheral device controller 50 comprises a peripheral device detector 51 which detects the peripheral devices 40, a peripheral device checker 52 which checks the operating states 52 of the detected peripheral devices 40, an operating state display output 53 which outputs the checked operating states, an application program runner 55 which runs the application programs 33 linked with the peripheral devices 40, and an application program installer 56 which installs the application programs 33 linked with the peripheral devices 40 in the hard disk drive 30.

The peripheral device detector 51 resides in the RAM while the operating system 31 is booted as the computer system is supplied with electric power. Thus, the peripheral device detector 51 detects the peripheral devices 40 connected to the ports 11 by generating an interrupt while the operating system 31 is being booted.

According to a detecting result of the peripheral device detector 51, the peripheral devices 40 are classified into two types. One type corresponds to peripheral devices 40 which are registered at the registry 35 of the hard disk drive 30, and the other type corresponds to peripheral devices 40 which are not registered at the registry 35 of the hard disk drive 30.

In a case where the peripheral devices 40 are registered at the registry 35, the peripheral device detector 51 transmits the detected result to the peripheral device checker 52, and the operating state display output 53 outputs the operating state of the peripheral devices 40 to the monitor 3.

Oppositely, in a case where the peripheral devices 40 are not registered in the registry 35, the peripheral device detector 51 drives a peripheral device installer 54 to register the peripheral device 40 at the registry 35.

The peripheral device installer 54 registers the peripheral devices 40 at the registry 35 through a PnP (plug and play) of the Windows operating system. Further, if no information on the peripheral device 40 is available from the device, the user is notified via the monitor 3 to register the peripheral device 40 manually at the registry 35 of the hard disk drive 30.

The peripheral device checker 52 checks the operating states of the peripheral devices 40 and transmits the checked result to the operating state display output 53, to display the operating state on the monitor 3.

A process of checking the operating states of the peripheral devices 40 through the peripheral device checker 52 is as follows. First, the peripheral device checker 52 interrupts the peripheral devices 40 detected by the peripheral device detector 51, and requests information on the operating states from the peripheral devices 40. It will be appreciated that the invention is applicable to displaying other states of the peripheral devices 40. Then, the peripheral devices 40 transmit the operating states thereof to the peripheral device checker 52 through the ports 11. For instance, the digital camera 43 transmits information on a memory, the remaining capacity of a battery, etc., to the peripheral device checker 52 through the USB port 13.

Data transmission between the peripheral devices 40 and the peripheral device checker 52 is accomplished by a predetermined program, namely, an AV-MAIN.DLL file. The AV-MAIN.DLL file is a program for transmitting data between a micro controller (not shown) provided in the peripheral device 40 and the main board 20.

The peripheral device checker 52 requests information on the peripheral devices 40 (e.g., a version of device driver thereof, a resource thereof, IRQ, etc.) from the registry 35 of the hard disk drive 30 as well as the information on the operating state from the peripheral device 40, and transmits the requested information to the operating state display output 53.

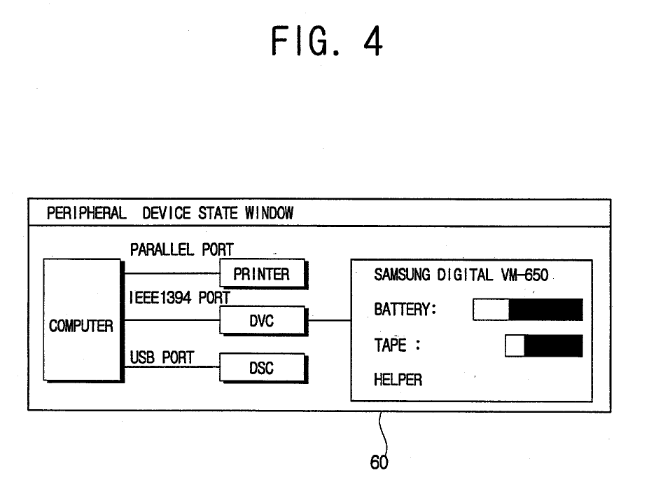

The operating state display output 53 receives the information and the operation state of the peripheral device 40 detected by the peripheral device detector 51 from the peripheral device checker 52, and outputs the received information which includes the operation state to a peripheral device state window 60, shown in FIG. 4, displayed on the monitor 3, thereby allowing a user to easily know about the peripheral devices 40 installed on the computer system.

The peripheral device state window 60 is popped up by the operating state display output 53 and will be described in more detail, referring to FIG. 4 and the digital camcorder 41 connected to the IEEE1394 port 15 will be described as one example of the peripheral devices 40. Information such as for example, the trade name of the peripheral devices 40 (e.g., SAMSUNG digital recorder VM-650), a remaining capacity of a battery and a remaining amount of a recording tape is displayed on the peripheral device state window 60 as the operating state of the peripheral devices 40. Further, a helper is provided at the bottom of the peripheral device state window 60, thereby helping a user to easily use the peripheral device display window 60.

Further, the operating state display output 53 drives the application program runner 55 to run the application program 33 linked with the peripheral device 40 (e.g., a digital picture edit program linked with the digital camcorder 41). Thus, while the operating state display output 53 displays the operating state of the peripheral device 40 on the monitor 3, the application program runner 55 runs the application program 33 linked with the peripheral device 40 and stored in the hard disk drive 30, thereby allowing a user to easily use the peripheral device 40.

If the application program 33 linked with the peripheral device 40 is not installed in the hard disk drive 30, the peripheral device controller 50 operates the application program installer 56.

The application program installer 56 automatically installs the application program 33 linked with the peripheral device 40 if the application program is not installed in the hard disk drive 30. Therefore, the application program installer 56 includes programs to install the application programs 33 linked with the peripheral devices 40. Further, the application program installer 56 outputs an error message if the application program 33 linked with the peripheral device 40 is not installed in the hard disk drive 30, thereby allowing a user to manually install it.

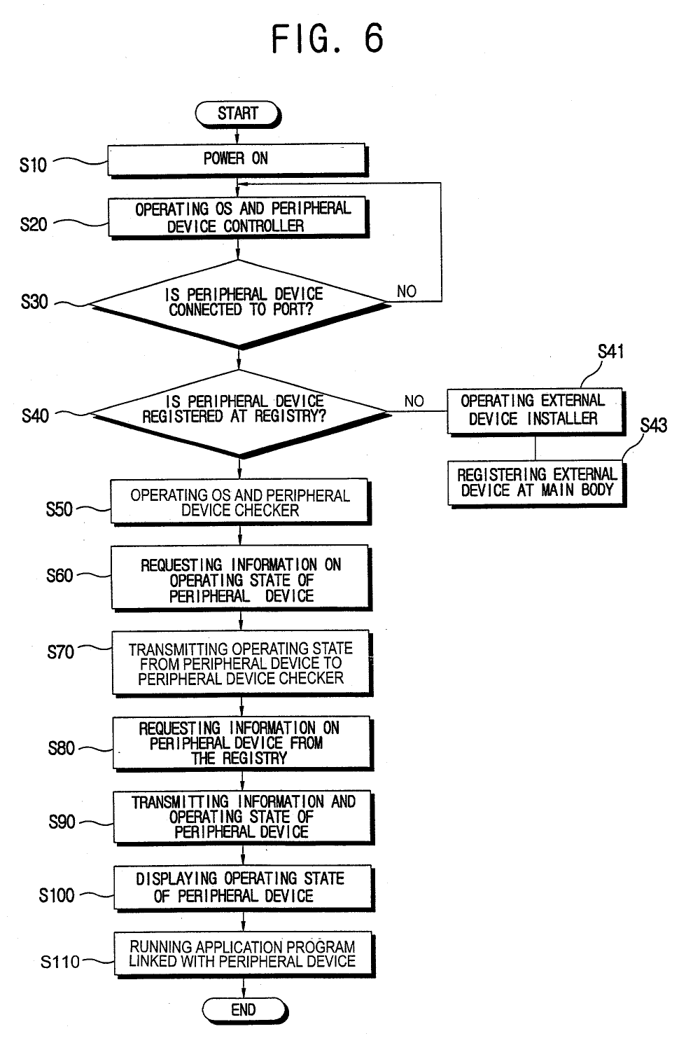

With the configuration described above, in the computer system according to the present invention, the process of outputting the operating state of the peripheral devices 40, which are connected to the ports 11 provided in the outside of the casing 10, to the monitor 3 will be described, referring to FIG. 6.

Referring to FIG. 6, the computer system is supplied with electric power (S10). Then, the BIOS-ROM 21 boots the computer system with the operating system 31 stored in the hard disk drive 30 after going through POST (power on self test). At this time, the peripheral device controller 50, which is a program in the RAM, operates while the operating system 31 is booted (S20).

The peripheral device detector 51 of the peripheral device controller 50 detects whether the peripheral devices 40 connected to the ports 11 by interrupting the peripheral devices 40 while the operating system 31 is booted (S30). If the peripheral device 40 is connected to the ports 11, the peripheral device detector 51 checks whether the peripheral device 40 is registered at the registry 35 (S40).

If the peripheral device 40 (e.g., the digital camcorder 41) is registered at the registry 35, the peripheral device detector 51 drives the peripheral device checker 52 (S50).

The peripheral device checker 52 interrupts the peripheral devices 40 detected by the peripheral device detector 51, and requests information on the operating state from the peripheral device 40 (S60). Then, the peripheral device 40 transmits the operating state of the peripheral device 40 (remains of a battery, a tape memory, etc.) to the peripheral device checker 52 by means of the AV-MAIN.DLL file (S70). The peripheral device checker 52 requests information (trade name) on the digital camcorder 41 from the registry 35 of the hard disk drive 30 (S80), and transmits the information and the operating state of the peripheral device 40 to the operating state display output 53 (S90).

The operating state display output 53 receives the information and the operation state of the peripheral device 40 from the peripheral device checker 52, and outputs the information and operation state to the monitor 3 (see FIG. 4) (S100). Further, the operating state display output 53 drives the application program runner 55 to run the application program 33 linked with the peripheral device 40, such as for example, a digital picture edit program linked with the digital camcorder 41.

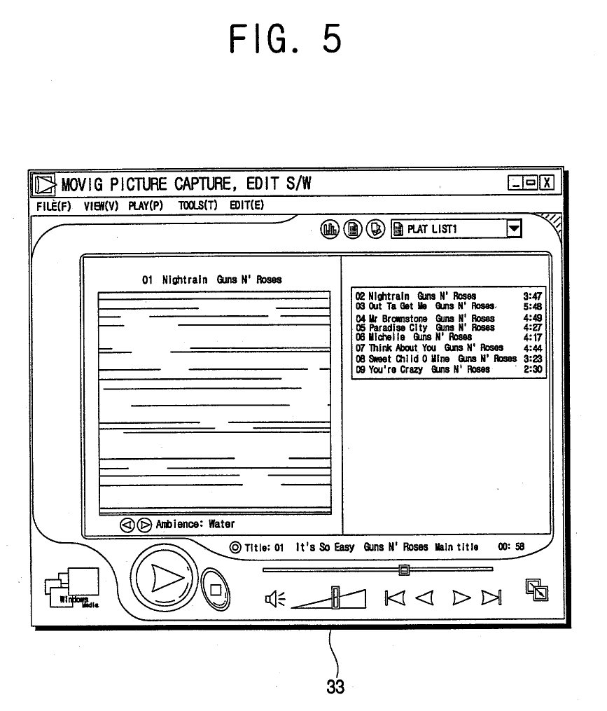

Thus, in the case of the digital camcorder 41, the application program runner 55 runs the application program 33 linked with the digital camcorder 41 (see FIG. 5), while the operating state display output 53 displays the operating state of the peripheral devices 40 on the monitor 3 (S110). Consequently, compared with the conventional computer system, the computer system according to the present invention allows a user to know about the operating state of the peripheral devices 40 connected to the ports 11 by observing the peripheral device display window 60 on the monitor 3.

If a determination is made at operation S40 that the peripheral device 40 is not registered at the registry 35, the peripheral device detector 51 drives the peripheral device installer 54 (S41) to register the peripheral device 40 (e.g., the digital camcorder 41) at the registry 35 (S43).

If the application program 33 linked with the peripheral device 40 is not installed in the hard disk drive 30, the peripheral device controller 50 drives the application program installer 56 to automatically install the application program 33 linked with the peripheral device 40 at operation S10.

The peripheral device controller 50 is provided as an application program installed in the hard disk drive 30. Alternatively, the peripheral device controller 50 may be provided as a processor chip (not shown) mounted on the main board 20. Where the processor chip is used, the processor chip has an application program corresponding to the peripheral device controller 50. If the processor chip is employed as the peripheral device controller 50, the cost of production is increased but the processing speed of the computer system is relatively increased.

As described above, in the main body is provided a peripheral device controller which checks operating states of peripheral devices and displays the operating states on a monitor, thereby allowing a user to know about the operating states of the peripheral devices connected to the ports.

As described above, the present invention provides a computer system and a method of indicating an operating state of peripheral devices thereof, which can indicate useful information on the peripheral devices.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A computer system, comprising:
a main body having a port connectable to a peripheral device;
a monitor which displays a video signal received from the main body; and
a peripheral device controller which:
detects whether the peripheral device is connected to the port,
checks an operating state of the peripheral device where the peripheral devices is connected to the port, and
outputs the operating state of the peripheral device.

2. The computer system according to claim 1, wherein the peripheral device controller comprises:
a peripheral device detector which detects whether the peripheral device is connected to the port;
a peripheral device checker which checks the operating state of the peripheral device if the peripheral device is connected to the port; and
an operating state display output which outputs the operating state of the peripheral device checked by the peripheral device checker.

3. The computer system according to claim 2, wherein the peripheral device controller further comprises a peripheral device installer which registers a peripheral device at the main body where a new peripheral device is mounted on the main body.

4. The computer system according to claim 2, wherein:
the main body further comprises an application program linked with the peripheral device, and
the peripheral device controller further comprises an application program runner which runs the application program while the monitor displays the operating state of the peripheral device.

5. The computer system according to claim 4, wherein:
the peripheral device controller further comprises an application program installer which installs the application program linked with the peripheral device in the main body where the application program linked with the peripheral device is not installed in the main body.

6. The computer system according to claim 2, wherein:
the port comprises at least one of a serial port, a parallel port, a USB port and an IEEE1394 port, and
the peripheral device comprises at least one of a printer, a digital camcorder, a digital camera and an MP3 player.

7. The computer system according to claim 2, wherein:
the main body further comprises a registry registering information on the peripheral device; and
the information displayed on the monitor comprises:
information on the peripheral device registered at the registry, and
information about the operating state of the peripheral device.

8. A method of indicating an operating state of a peripheral device in a computer system having a main body mounted with a port to which the peripheral device is connectable, and a monitor which outputs a video signal received from the main body, the method comprising:
detecting whether the peripheral device is connected to the port;
checking the operating state of the peripheral device if the peripheral device is connected to the port; and
displaying the operating state of the peripheral device on the monitor.

9. The method according to claim 8, wherein the checking of the operation state comprises:
requesting information on the operating state of the peripheral device from the peripheral device; and
transmitting the operating state of the peripheral device through the port.

10. The method according to claim 8, wherein the detecting of whether the peripheral device is connected to the port further comprises:
registering the peripheral device at the main body where a new peripheral device is mounted on the main body.

11. The method according to claim 8, wherein:
the main body further comprises an application program linked with the peripheral device, and
the displaying of the operating state of the peripheral device further comprises running the application program while the monitor displays the operating state of the peripheral device.

12. The method according to claim 11, wherein the running of the application program further comprises installing the application program linked with the peripheral device in the main body if the application program linked with the peripheral device is not installed in the main body.

13. The method according to claim 8, wherein:
the main body further comprises a registry which registers information on the peripheral device; and
the information displayed on the monitor comprises information on the peripheral device registered at the registry, and the operating state of the peripheral device.

14. A computer system, comprising:
a monitor which presents data to a user in usable form;
a port through which a peripheral device is connectable to the computer system;
a registry which stores first data about the peripheral device;
a peripheral device controller which:
detects whether the peripheral device is connected to the port;
determines if the first data is stored in the registry if the peripheral device is connected to the port; and
if the peripheral device is connected to the port and the first data is stored in the registry, the peripheral device controller:
collects second data representing an operation state of the peripheral device from the peripheral device,
collects the first data from the registry, and
outputs the first and second data as the user data.

15. The computer system according to claim 14, wherein:
if the peripheral device is connected to the port and the first data is not stored in the registry, the peripheral device controller acquires the first data from the peripheral device and stores the first data in the registry.

16. The computer system according to claim 15, wherein:
if the first data is not available from the peripheral device, the peripheral device controller provides user data to notify the user to enter the first data manually.

17. The computer system according to claim 14, wherein the peripheral device controller further runs an application program linked with the peripheral device while the monitor displays the user data corresponding to the first and second data.

18. The computer system according to claim 17, wherein the peripheral device comprises at least one of a printer, a digital camcorder, a digital camera and an MP3 player.

19. The computer system according to claim 14, wherein the computer system further comprises a hard disk drive and a central processing unit and the peripheral device controller is provided as an application program which is stored on the hard disk and executed by the central processing unit.

20. The computer system according to claim 14, wherein the computer system further comprises a central processing unit and the peripheral controller is provided as a processor chip independently of the central processing unit.

21. A method of providing user information on an operating state of a peripheral device connectable to a computer system, the method comprising:
registering first data about the peripheral device in a registry of the computer;
detecting whether the peripheral device is connected to the computer;
determining if the first data is stored in the registry; and
if the peripheral device is determined to be connected to the computer and the first data is stored in the registry:
collecting second data representing an operation state of the peripheral device from the peripheral device,
collecting the first data from the registry, and
presenting the first and second data to the user as the user information.

22. The method according to claim 21, wherein:
if the peripheral device is determined to be connected to the port and the first data is not stored in the registry, acquiring the first data from the peripheral device and storing the first data in the registry.

23. A computer readable medium which provides instructions for determining an operating state of a peripheral device connectable to a computer, the computer readable medium comprising:
a first area which stores instructions which cause the computer to detect whether the peripheral device is connected to the computer; and
a second area which stores instructions which cause the computer:
to determine if first data about the peripheral device is stored in a registry of the computer, and if the peripheral device is determined to be connected to the computer and the first data is stored in the registry, the instructions cause the computer to:
collect second data representing an operation state of the peripheral device from the peripheral device,
collect the first data from the registry, and
present the first and second data to the user as user information,

24. The computer readable medium according to claim 23, wherein the computer readable medium further comprises:
a third area which stores instructions which cause the computer to acquire the first data from the peripheral device if peripheral device is determined to be connected to the port and the first data is not stored in the registry.

25. The computer readable medium according to claim 24, wherein the computer readable medium further comprises:
a fourth area which stores instructions which cause the computer to notify the user to manually enter the first data in the if the first data is not available from the peripheral device.
